(19) United States
(12) Patent Application Publication
(10) Pub. No.: US 2005/0062689 A1
(43) Pub. Date: Mar. 24, 2005

(54) Method of driving a display panel

(75) Inventor: Hirokazu Hashikawa, Yamanashi-ken (JP)

Correspondence Address: MORGAN LEWIS & BOCKIUS LLP, 1111 PENNSYLVANIA AVENUE NW, WASHINGTON, DC, 20004, US

(73) Assignee: Pioneer Corporation

(21) Appl. No.: 10/945,092

(22) Filed: Sep. 21, 2004

(30) Foreign Application Priority Data
Sep. 22, 2003 (JP) 2003-330387

(51) Int. Cl. G09G 3/28

(52) U.S. Cl. 345/60

(57) ABSTRACT

One field is divided into a plurality of subfield groups. Each subfield group includes M successively arranged subfields. In each subfield group, the subfields are arranged in the order of increasing or decreasing light emission period in the sustain stage. The subfields are disposed so that the total period of light emission periods that have been allocated to the subfields of one subfield group and a total period of light emission periods that have been allocated to the subfields of another subfield group are almost identical. In each subfield group, the state of a display cell (light emission mode or non-light emission mode) is changed only in the address stage of one subfield among the M subfields.

### BACKGROUND OF THE INVENTION

1. Field of the Invention

The present invention relates to a drive method for a display panel.

2. Description of the Related Art

Plasma display devices carrying plasma display panels (referred to as “PDPs”) are presently marketed as commercial products. The PDP is a large and thin color display panel.

FIG. 1 of the accompanying drawings illustrates schematically the configuration of such plasma display device.

Referring to FIG. 1, a PDP 10 includes m band-like column electrodes D₁-Dₘ and n band-like row electrodes X₁-Xₙ and n band-like row electrodes Y₁-Yₙ. The row electrodes Xᵢ and Yᵢ are arranged so as to cross the column electrodes Dᵢ. Discharge spaced filled with a discharge gas are formed between the column electrodes Dᵢ and the row electrodes Xᵢ and Yᵢ. A pair of row electrodes Xᵢ, Yᵢ defines a display line in the PDP 10. A discharge cell is formed in each crossing zone of each row electrode pair and column electrode, including the discharge space. Pixels are formed by the discharge cells.

Because each discharge cell emits light by using the discharge effect, there are only two states: a “light emission state”, in which light is emitted with the prescribed brightness, and a “non-light emission state”. In other words, the discharge cell has only two brightness levels. A drive device 100 of the PDP 10 having such discharge cells executes a gray level drive using a subfield method so that the PDP 10 can create an intermediate tone (or grayscale image) corresponding to an input video signal.

FIG. 2 of the accompanying drawings illustrates an example of a light emission drive sequence within one field period based on such a subfield method. This is disclosed in Japanese Patent Kokai (Laid-open Publication) No. 2000-231362.

In this light emission drive sequence, the drive of the PDP 10 is carried out with fourteen subfields. The display period of one field is divided into the subfields SF1-SF14. Within each subfield, a pixel data write stage Wc and a sustain light emission stage Ic are executed. The pixel data write stage Wc writes pixel data into the discharge cells of the PDP 10 so as to set the discharge cells into either a light emission state or a non-emission state. The sustain light emission stage Ic causes and sustains light emission in only the discharge cells of the light-emission state. A simultaneous reset stage Rc for initializing all the discharge cells of the PDP 10 is executed only in the head subfield SF1, and an erasure stage E is executed only in the very last subfield SF14.

FIG. 3 of the accompanying drawings shows the application timing of drive pulses applied by the drive unit 100 to the column electrodes of the PDP 10 D₁-Dₘ and row electrodes X₁-Xₙ and Y₁-Yₙ according to this light emission drive sequence. This is also disclosed in Japanese Patent Kokai No. 2000-231362.

In the simultaneous reset stage Rc, reset pulses RPₓ and RP_{y} are simultaneously applied to the row electrodes X₁-Xₙ and Y₁-Yₙ. As a result of the application of the reset pulses RPₓ and RP_{y}, all the discharge cells in the PDP 10 are reset and discharged so that wall charges of prescribed quantity are formed inside each discharge cell. Therefore, all the discharge cells in the PDP 10 are initialized into the light-emission state which can perform discharge light emission in the sustain light emission stage Ic.

In the pixel data write stage Wc, pixel data pulses for pixels having pulse voltages corresponding to the input video signal are successively applied to the column electrodes D₁-Dₘ by one display line at a time. In other words, pixel data pulse groups DP, each being composed of m pixel data pulses, are applied successively to the column electrodes D₁-Dₘ for the first display line to the n-th display line as shown in FIG. 3. Further, scanning pulses SP are generated and successively applied to the row electrodes Y₁-Yₙ at the same timing as the application timing of each pixel data pulse group DP as shown in FIG. 3. As a result, a discharge (selective erasure discharge) is generated only in those discharge cell in the intersection zones of the row electrode pairs X, Y to which the scanning pulse SP is applied and the column electrodes D to which a high-voltage pixel data pulse is applied, and the wall charge remaining inside these discharge cells is erased. With such a selective erasure discharge, the discharge cells that are initialized into the light emission state in the simultaneous reset stage Rc are converted into non-emission state. No discharge is induced in other discharge cells to which the high-voltage pixel data pulse is not applied, and the state initialized in the simultaneous reset stage Rc, that is, the light emission state, is maintained.

Thus, executing the pixel data write stage Wc sets each discharge cell to a light-emission state capable of discharge emitting light in the below described sustain light emission stage Ic or to a non-emission state.

In each sustain emission stage Ic, the sustain pulses IPₓ and IP_{y} are alternately applied, as shown in FIG. 3, to the row electrodes X₁-Xₙ and Y₁-Yₙ. At this time, only those discharge cells which are set as the light-emission cells in the pixel data writing stage Wc are discharged each time the sustain pulses IPₓ and IP_{y} are applied, and the light emission state caused by this discharge is sustained. The number of discharge light emissions caused in the sustain light emission stage Ic differs for each subfield, as shown in FIG. 2.

FIG. 4 of the accompanying drawings shows a light emission drive pattern executed in accordance with the light emission drive sequence of FIG. 2.

With the drive scheme shown in FIG. 4, the selective erasure discharge is induced in each discharge cell (shown by black circles) only in the pixel data write stage Wc of one subfield among the subfields SF1-SF14. Thus, the drive unit 100 applies a high-voltage pixel data pulse to the discharge cell corresponding to each pixel only in the pixel data write stage Wc of one subfield among the subfields SF1-SF14. The drive unit 100 applies, in the pixel data write stages Wc of other subfields, a low-voltage pixel data pulse to the discharge cells. To which pixel data write stage Wc (or to which subfield) the high-voltage pixel data pulse has to be applied is determined on the basis of the brightness level represented by the pixel data. With such an operation, each discharge cell functions as a light-emitting cell within an interval before the selective erasure discharge is executed in one field period, and discharge light emission is carried out in the sustain light emission stage Ic of each of the subfields present within this interval. As a result, the brightness can be viewed (perceived) which corresponds to a total number of light emissions caused by the discharges induced in the sustain light emission stages Ic within one field display period.

Therefore, an intermediate brightness of 15 gradations with different brightness levels can be represented with the 15 light emission drive patterns shown in FIG. 4.

With such a drive method, a discharge cell that has once assumed a non-light emission state does not return to the light emission state within one field period. Therefore, a dynamic image pseudo-contour can be suppressed. However, because the number of gray levels that can be represented is “the number of subfields into which each field is divided +1”, all the intermediate brightness levels represented by the input video signal cannot be represented. To overcome this shortcoming, the error diffusion processing and dithering are also performed in the above-described drive method.

Such an increase in the number of gray levels by the error diffusion processing and dithering, however, increases noise in the displayed image.

### SUMMARY OF THE INVENTION

One object of the present invention is to provide a drive method for a display panel which can reduce noise in a displayed image and create a high-quality image, while suppressing the dynamic image pseudo-contour.

According to one aspect of the present invention, there is provided an improved drive method for causing a display panel to perform gray level display based on an input video signal. The display panel has a plurality of display cells that serve as pixels. The display panel is driven field by field. Each field has N (N is integer of 2 or more) subfields. Each subfield has an address stage and a sustain stage. The address stage sets the display cell into either a light emission mode or a non-light emission mode according to pixel data derived from the input video signal. The sustain stage causes only that display cell, which is set into the light emission mode, to emit light over a light emission period allocated in advance. Each field is divided into a plurality of subfield groups. Each subfield group has M (2≦M≦N/2) subfields that are successively arranged. The subfields in each subfield group are arranged in the order of increasing or decreasing allocation of the light emission period. A total period of the light emission periods that have been allocated to the subfields belonging to one subfield group is almost equal to a total period of the light emission periods that have been allocated to the subfield belonging to another subfield group. In each subfield group, a state of the display cell is changed from the light emission mode to the non-light emission mode (or from the non-light emission mode to the light emission mode) only in the address stage of one subfield among the M subfields.

This drive method can achieve high-quality gray level display with reduced noise in a displayed image, while suppressing the dynamic image pseudo-contour.

These and other objects, aspects and advantages of the present invention will become apparent to those skilled in the art from the following detailed description and appended claims when read and understood in conjunction with the accompanying drawings.

### BRIEF DESCRIPTION OF THE DRAWINGS

FIG. 1 illustrates schematically the configuration of a display device having a plasma display panel (PDP);

FIG. 2 shows a light emission drive sequence for driving the PDP shown in FIG. 1;

FIG. 3 shows various drive pulses applied to the PDP in accordance with the light emission drive sequence in FIG. 2;

FIG. 4 shows a light emission drive pattern based on the light emission drive sequence shown in FIG. 2;

FIG. 5 illustrates the configuration of an example of a display device having a plasma display panel, which is operated by the drive method of the present invention;

FIG. 6 illustrates the light emission drive sequence according to a first embodiment of the present invention;

FIG. 7 shows an example of the light emission drive pattern based on the light emission drive sequence shown in FIG. 6;

FIG. 8 illustrates the light emission drive sequence according to a second embodiment of the present invention;

FIG. 9 and FIG. 10 show in combination an example of the light emission drive pattern based on the light emission drive sequence shown in FIG. 8;

FIG. 11 illustrates the light emission drive sequence according to a third embodiment of the present invention;

FIG. 12 and FIG. 13 show in combination an example of the light emission drive pattern based on the light emission drive sequence shown in FIG. 11;

FIG. 14 illustrates the light emission drive sequence according to a fourth embodiment of the present invention; and

FIG. 15 shows an example of the light emission drive pattern based on the light emission drive sequence shown in FIG. 14.

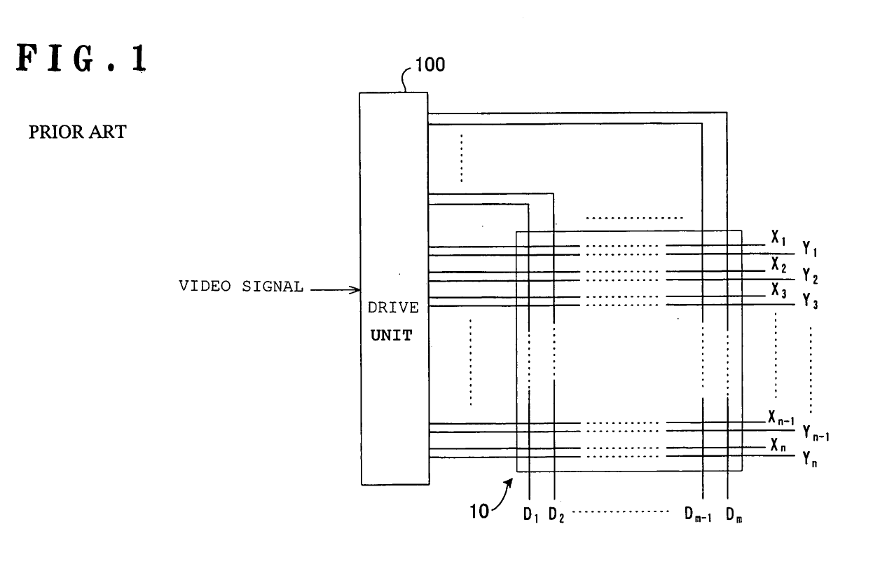

### DETAILED DESCRIPTION OF THE INVENTION

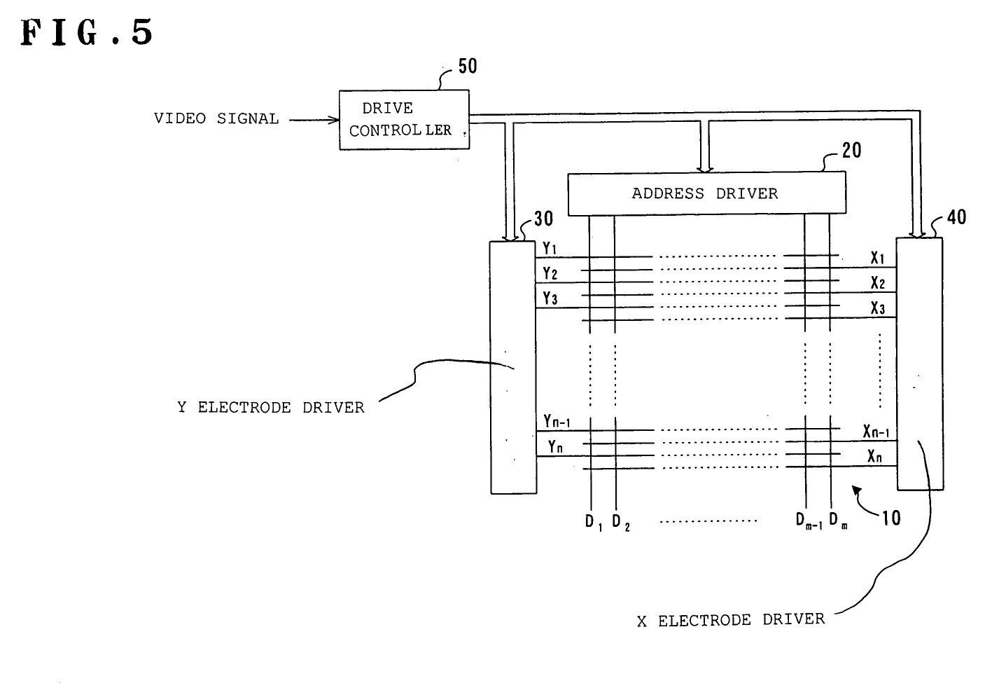

Referring to FIG. 5, the configuration of a plasma display device having a plasma display panel (PDP) 10 will be described. This plasma display device is driven by a drive method of the present invention.

This plasma display device includes a panel drive unit and the PDP 10. The panel drive unit includes an address driver 20, an Y electrode driver 30, an X electrode driver 40, and a drive control circuit 50.

The PDP 10 includes m band-like column electrodes D₁-Dₘ and n band-like row electrodes X₁-Xₙ and n band-like row electrodes Y₁-Yₙ. The row electrodes Xᵢ, Yᵢ are arranged so as to cross the column electrodes Dᵢ. The column electrodes D are addressing electrodes. Discharge spaces filled with a discharge gas are formed between the column electrodes D and the row electrodes Xᵢ and Yᵢ. In the PDP 10, each pair of row electrodes Xᵢ, Yᵢ defines one display line of the PDP 10. A discharge cell is formed in each crossing zone of each row electrode pair and column electrode, including the discharge space. The discharge cells form pixels.

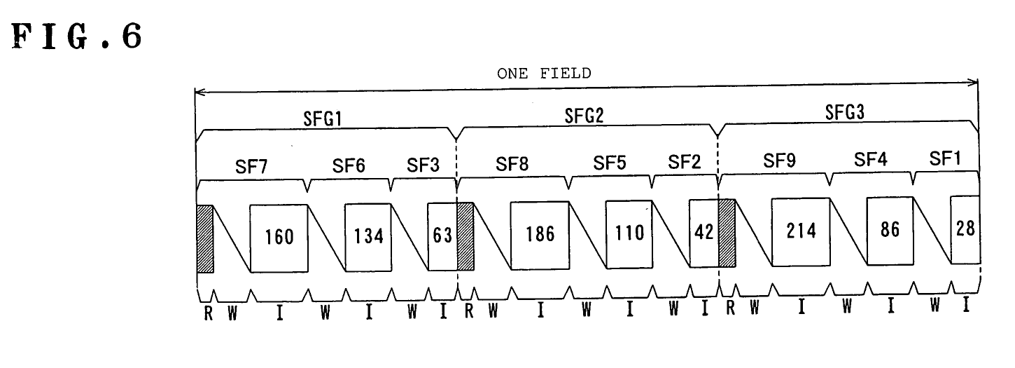

The drive control circuit 50 converts an input video signal into pixel data for each pixel. The drive control circuit 50 uses the pixel data to prepare pixel drive data that indicates whether the discharge cell concerned should be set into a light emission mode or non-light emission mode in the address stage W (described hereinbelow) of each subfield. The drive control circuit 50 supplies the pixel drive data to the address driver 20. The drive control circuit 50 also generates timing signals according to the light emission drive sequence shown in FIG. 6 and supplies them to the Y electrode driver 30 and X electrode driver 40. The address driver 20, Y electrode driver 30, and X electrode driver 40 apply various drive pulses to the column electrodes D and row electrodes X and Y of the PDP 10 according to the light emission drive sequence.

FIG. 6 shows an example of light emission drive sequence. One field is divided into 9 subfields SF1-SF9 in this embodiment.

In the light emission drive sequence shown in FIG. 6, the address stage W and sustain stage I are respectively executed in each of the subfields SF1-SF9. In the address stage W, the panel drive unit selectively induces the write address discharge, according to the pixel drive data, in the discharge cells of the PDP 10. As a result, a wall charge of certain quantity is formed inside the discharge cell in which the write address discharge is induced. These discharge cells are set into a light emission mode. The discharge light emission can be conducted in these discharge cells during a sustain stage I (will be described). On the other hand, the discharge cell in which the write address discharge is not induced sustains the immediately preceding state (light emission mode or non-light emission mode). In other words, with the address stage W, each discharge cell is set either to the light emission mode or non-light emission mode according to the pixel drive data. A certain light emission period is allocated in advance to each subfield. In each sustain stage I, the panel drive unit causes a repeated sustain discharge light emission only in the discharge cell that is set into the light emission mode for the period that is allocated to the subfield SF to which the sustain stage I belongs. As shown below and illustrated in FIG. 6, the ratio of discharge light emission periods allocated to the sustain periods I of the subfields SF1-SF9 is:
SF1: 28
SF2: 42
SF3: 63
SF4: 86
SF5: 110
SF6: 134
SF7: 160
SF8: 186
SF9: 214.

In the light emission drive sequence shown in FIG. 6, the subfields SF1-SF9 are executed in the following order within each field:
SF7
SF6
SF3
SF8
SF5
SF2
SF9
SF4
SF1.

The subfields SF7, SF6, and SF3 form a first subfield group SFG1, the subfields SF8, SF5, and SF2 form the second subfield group SFG2, and the subfields SF9, SF4, and SF1 form the third subfield group SFG3. The total period of sustain discharge light emission induced in the sustain stages I within each of the subfield groups SFG1-SFG3 is as follows.
SFG1: 357 (=160+134+63).
SFG2: 338 (=186+110+42).
SFG3: 328 (=214+86+28).

In other words, the three subfields SF are so allocated to each of the subfield groups SFG1-SFG3 that no significant difference occurs between the total period of sustain discharge in the head period (SFG1), the total period of sustain discharge in the intermediate period (SFG2), and the total period of sustain discharge in the final period (SFG3) in one field. In each of the subfield groups SFG1-SFG3, as shown in FIG. 6, the subfields are arranged in the order of decreasing discharge light emission period allocated to the sustain stage I.

In the light emission drive sequence shown in FIG. 6, a reset stage R is executed prior to the address stage W in each head subfield in each of the subfield groups SFG1-SFG3, that is, in each of the subfields SF7, SF8, and SF9. The panel drive unit causes reset-discharging in all the discharge cells in the reset stages R to initialize the discharge cells into a non-light emission mode.

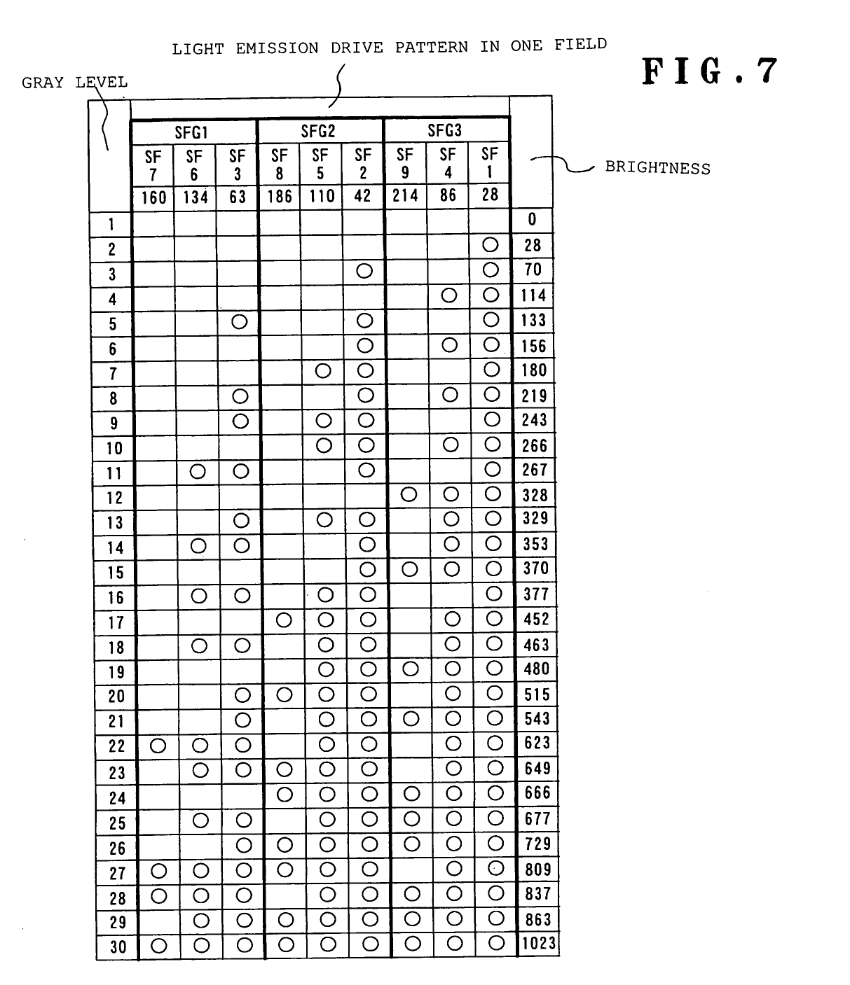

FIG. 7 shows a light emission drive pattern based on the light emission drive sequence shown in FIG. 6.

In the subfields SF denoted by white circles in FIG. 7, the discharge cells are set into a light emission mode and light emission is caused by the sustain discharge in the sustain stages I of these subfields SF. For example, with the 5th gray level drive shown in FIG. 7, light emission accompanying the sustain discharge is repeatedly conducted for a particular period (i.e., certain number of times) in the sustain stage I of each subfield SF3, SF2, and SF1. The light emission period is specific to each subfield, as mentioned earlier. In this embodiment, 63 sustain discharges are carried out in the subfield SF3, 42 sustain discharges are carried out in the subfield SF2, and 25 sustain discharges are carried out in the subfield SF1. Thus, a brightness corresponding to a total period of “133” is viewed.

Therefore, with the 1st to 30th gray level drive shown in FIG. 7, the following intermediate brightness representation of 30 gray levels is achieved: “0”, “28”, “70”, “114”, “133”, “156”, “180”, “219”, “243”, “266”, “267”, “328”, “329”, “353”, “370”, “377”, “452”, “463”, “480”, “515”, “543”, “623”, “649”, “666”, “677”, “729”, “809”, “837”, “863”, and “1023”.

With the drive shown in FIG. 6, the mode of the discharge cell can be changed from the light emission mode to the non-light emission mode in only the reset stage R of the head subfield SF7, SF8, and SF9 in each subfield group SFG1-SFG3. Therefore, once a discharge cell is set into a light emission mode in any one address stage W in the three subfields in each subfield group SFG, then the light emission mode is sustained till the last subfield in the subfield group SFG. Thus, light emission accompanying the sustain discharged is executed continuously, as shown by white circles in FIG. 7.

As shown in FIG. 7, the number of times that the state (light emission mode or non-light emission mode) of the discharge cell is reversed (opposite) between adjacent gray levels is 5 at maximum in the subfields SF1-SF9 (for example, between the 11th gray level and 12th gray level), that is, less than 6. Therefore, the dynamic image pseudo-contour can be suppressed by comparison with a drive method having a light emission drive pattern in which the states of discharge cells of all the subfields SF1-SF9 are reversed (opposite) between the adjacent gray levels (that is, the light emission drive pattern in which the number of reversions is 9).

Further, with the drive shown in FIG. 6 and FIG. 7, the total periods of sustain discharge in the subfield groups SFG1-SFG3 are almost the same. Therefore, the viewable brightness levels in the head period (SFG1), intermediate period (SFG2), and end period (SFG3) in the three sections of one field display period are almost uniform. Therefore, a good image display in which a flicker is suppressed can be obtained.

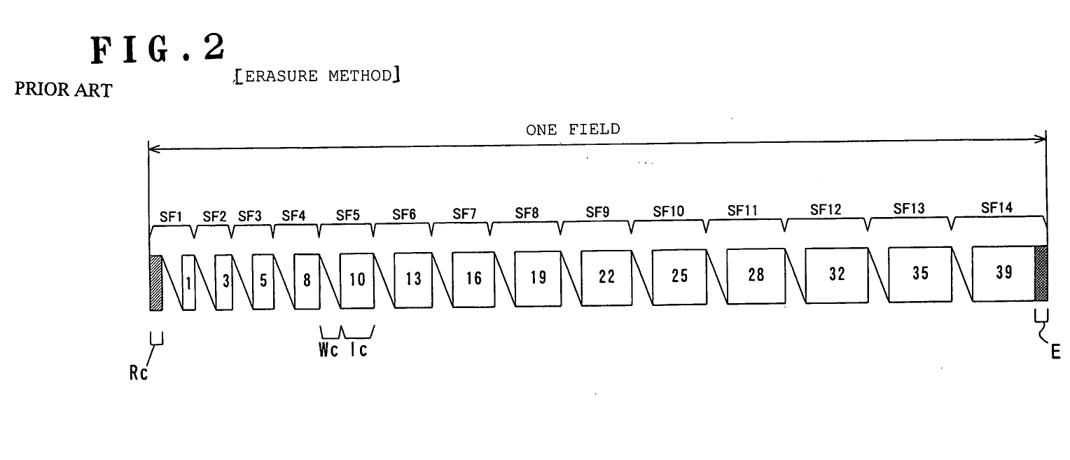

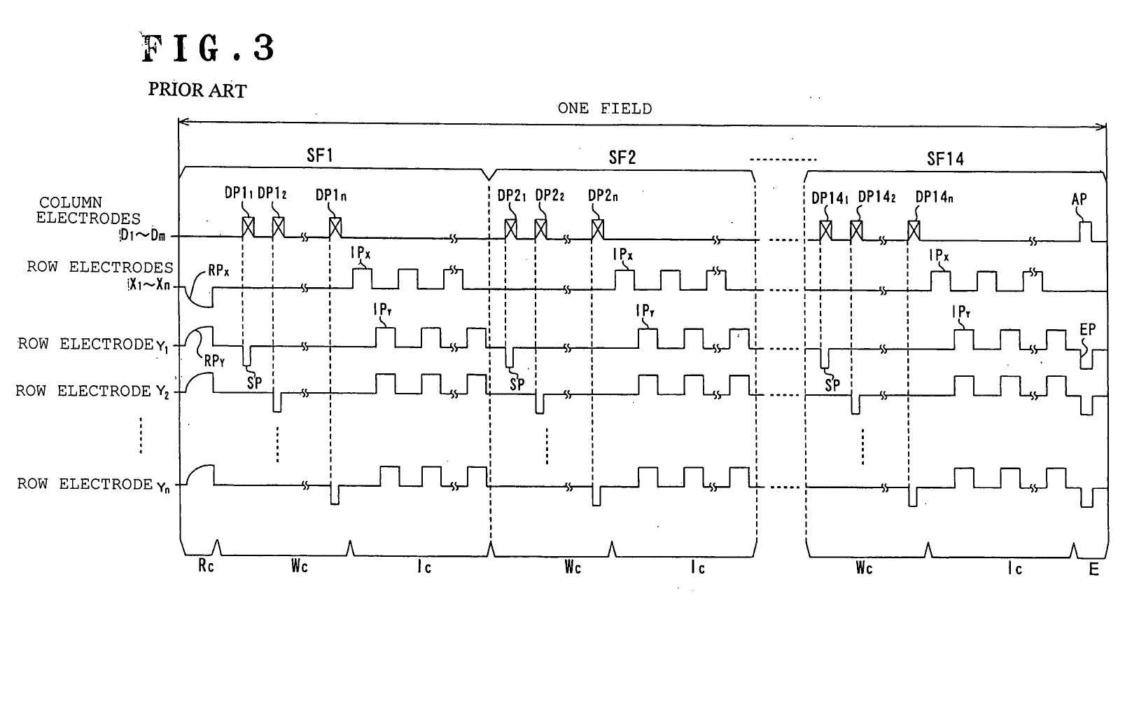

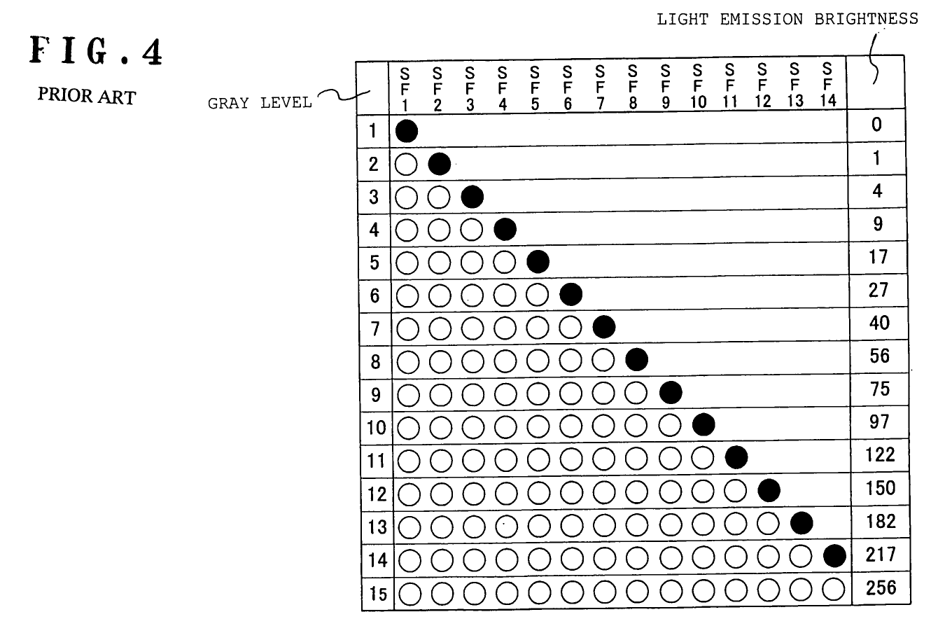

As described hereinabove, with the drive illustrated by FIG. 6 and FIG. 7, an intermediate brightness display with 30 gray levels is performed with 9 subfields, while suppressing flicker and dynamic image pseudo-contour. As a result, the number of brightness levels can be increased by comparison with the case of employing a drive method illustrated by FIG. 2 and FIG. 4. In FIG. 2 and FIG. 4, intermediate brightness display of (N+1) gray levels is achieved with N subfields with the object of suppressing the dynamic image pseudo-contour. Therefore, the increase in the number of gray levels, which should reply upon multitoning such as error diffusion processing and dithering, can be reduced and noise in the displayed image can be accordingly reduced.

In the above-described embodiment, the nine subfields SF1-SF9 are grouped into three subfield groups SFG1-SFG3 and a drive with 30 gray levels is carried out, but the present invention is not limited in these regards.

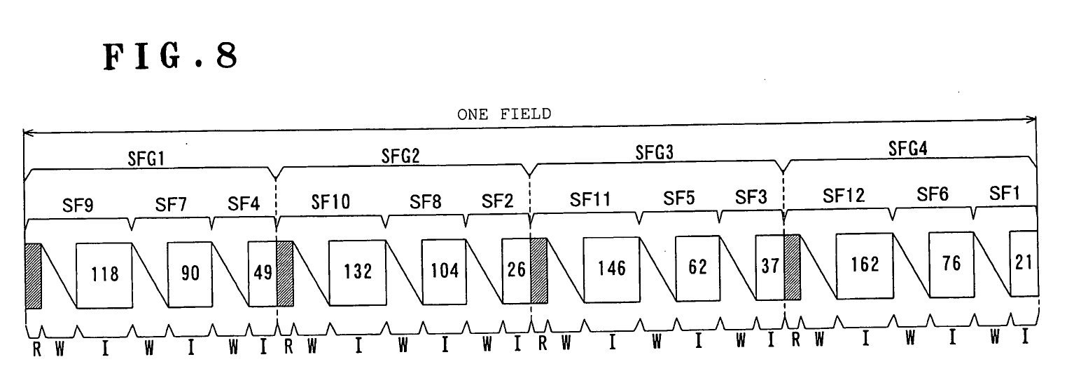

FIG. 8 shows a light emission drive sequence according to a second embodiment. One field is divided into twelve subfields SF1-SF12. Similar reference numerals are used in the first and second embodiments.

In the light emission drive sequence shown in FIG. 8, the address stages W and sustain stages I are executed in each of the subfields SF1-SF12. The operations in each of the address stages W and sustain stages I are the same as those shown in FIG. 6 and FIG. 7. With the light emission drive sequence shown in FIG. 8, the ratios of discharge light emission periods allocated to the sustains stages I in the subfields SF1-SF12 are as follows:
SF1: 21
SF2: 26
SF3: 37
SF4: 49
SF5: 62
SF6: 76
SF7: 90
SF8: 104
SF9: 118
SF10: 132
SF11: 146
SF12: 162.

With the light emission drive sequence shown in FIG. 8, the subfields SF1-SF12 in each field are executed in the following order.
SF9
SF7
SF4
SF10
SF8
SF2
SF11
SF5
SF3
SF12
SF6
SF1

The subfields SF9, SF7, and SF4 form the first subfield group SFG1, the subfields SF10, SF8, and SF2 form the second subfield group SFG2, the subfields SF11, SF5, and SF3 form the third subfield SFG3, and the subfields SF12, SF6, and SF1 form the fourth subfield group SFG4. The total period of sustain discharge light emission induced in the sustain stages I in each subfield group SFG1-SFG4 is as follows:
SFG1: 257 (=118+90+49)
SFG2: 262 (=132+104+26)
SFG3: 245 (=146+62+37)
SFG4: 259 (=162+76+21)

In other words, the total periods of sustain discharge in the four sections, i.e., the head section (SFG1) to the last section (SFG4), of one field are almost uniform. In each of the sections SFG1-SFG 4, the subfields are arranged in the order of decreasing discharge light emission period allocated to the sustain stage I.

Similar to the light emission drive sequence shown in FIG. 6, a reset stage R is executed prior to the address stage W in each head subfield of each subfield group SFG1-SFG4, that is, in the subfields SF9, SF10, SF11, and SF12. The operation in the reset stage R is identical to that illustrated by FIG. 6 and FIG. 7.

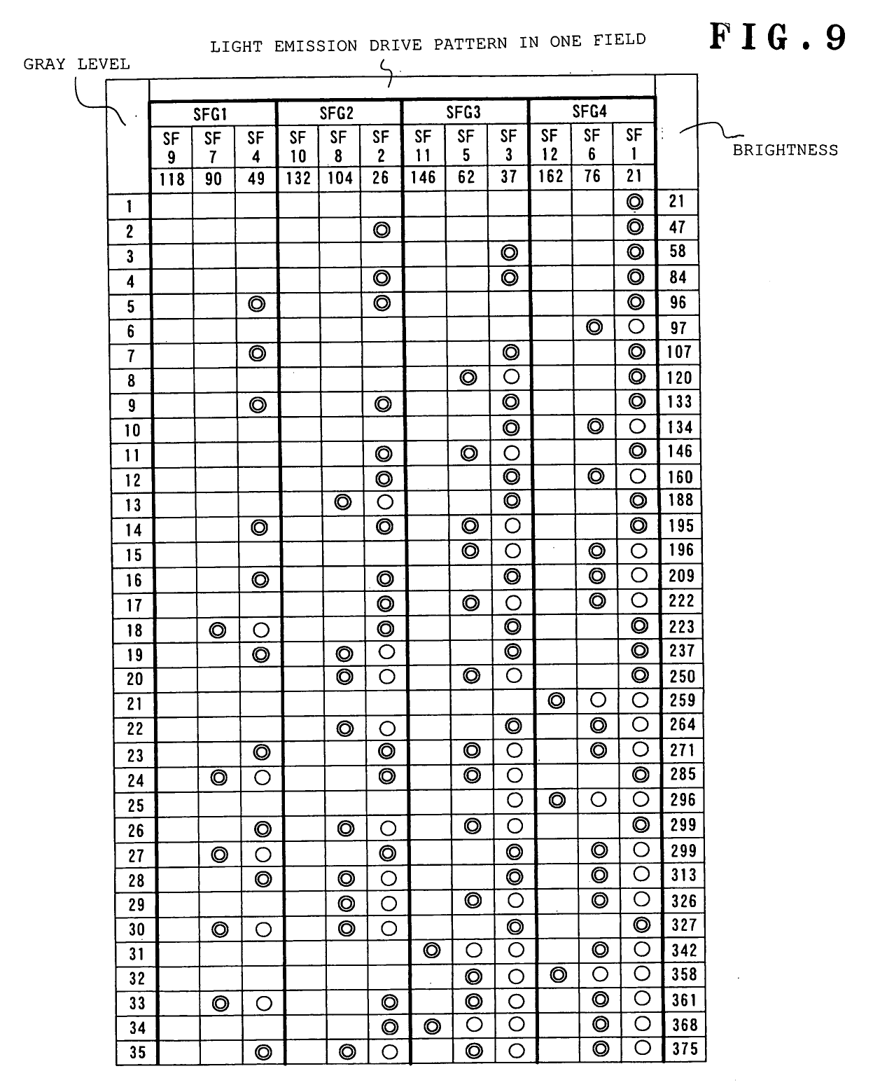

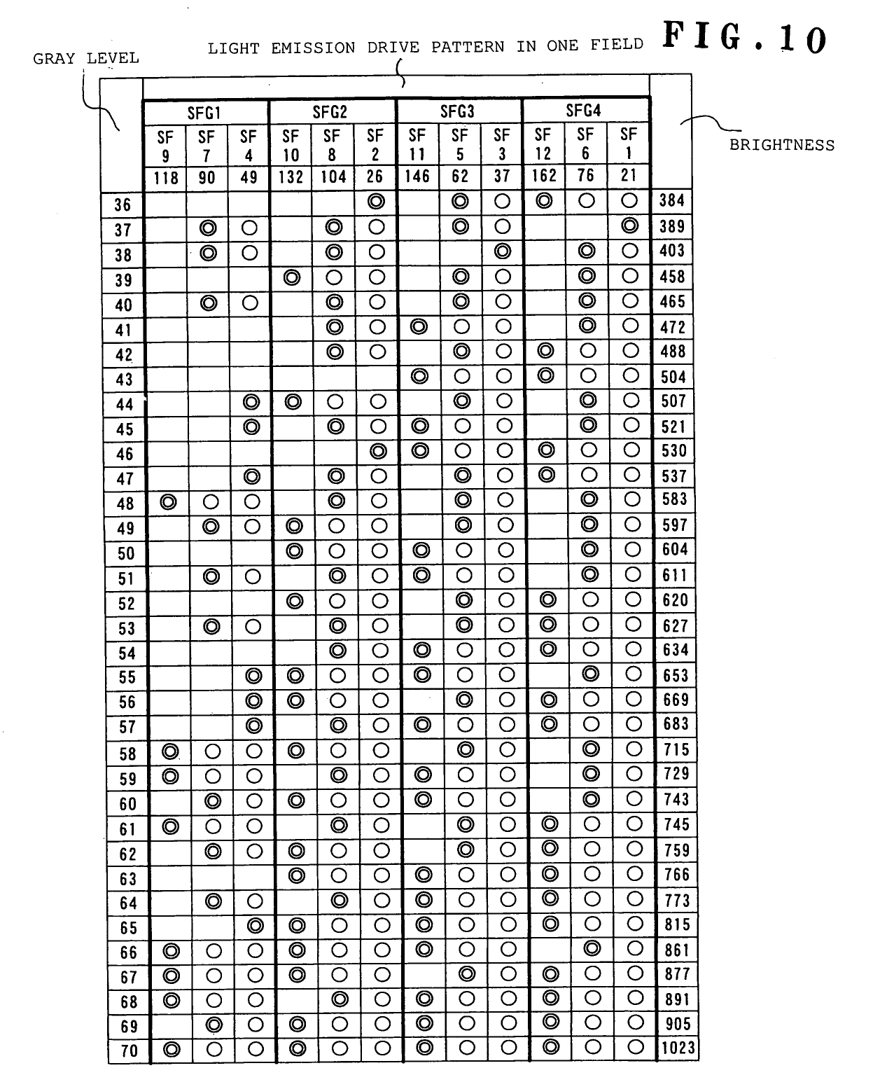

FIG. 9 and FIG. 10 illustrate in combination a light emission drive pattern based on the light emission drive sequence shown in FIG. 8.

Referring to FIG. 9 and FIG. 10, in the subfields SF denoted by double circles, a write address discharge is induced in the address stage W of the subfield, and the discharge cell is set into a light emission mode. In the subfields SF denoted by the double circles or single circles, light emission accompanying the sustain discharge is induced in the sustain stages I of these subfields SF. For example, with the 9^{th} gray level drive illustrated in FIG. 9, light emission accompanying the sustain discharge is repeatedly executed for a certain period (i.e., certain number of times) in the sustain stage I of each of the subfields SF4, SF2, SF3, and SF1. The light emission period is unique to the subfield. In this embodiment, 49 sustain discharges are executed in the subfield SF4, 26 sustain discharges are executed in the subfield SF2, 37 sustain discharges are executed in the subfield SF3, and 21 sustain discharges are executed in the subfield SF1. Thus, a brightness corresponding to a total period of “133” can be viewed.

Therefore, with the light discharge drive pattern shown in FIG. 9 and FIG. 10, 70-gray-level intermediate brightness display is possible. This display represents perceivable “21”-“1023” brightness levels in 70 gray levels.

With the drive shown in FIG. 8 to FIG. 10, the mode of the discharge cell can be changed from the light emission mode to the non-light emission mode in only the reset stage R of the head subfield SF9, SF10, SF11, and SF12 in each subfield group SFG1-SFG4. Therefore, if a discharge cell is set into a light emission mode in any one address stage W in the three subfields in each subfield group SFG, then the light emission mode is sustained till the last subfield in the subfield group SFG.

As shown in FIG. 9 and FIG. 10, the number of times that the state (light emission mode or non-light emission mode) of the discharge cell is reversed (opposite) between adjacent gray levels is 7 at maximum in the subfields SF1-SF12 (for example, between the 30^{th} gray level and 31^{st} gray level), that is, less than 8. Therefore, the dynamic image pseudo-contour can be suppressed if compared with a drive method having a light emission drive pattern in which the states of discharge cells of all the subfields SF1-SF12 are reversed between the adjacent gray levels (that is, the number of reversions is 12). Further, with the drive shown in FIGS. 8 to 10, the total periods of sustain discharge in the subfield groups SFG1-SFG4 are almost the same. Thus, the viewable brightness levels in the head period (SFG1), first intermediate period (SFG2), second intermediate period (SFG3), and end period (SFG4) of one field display period are almost uniform. Therefore, a good image display in with a reduced flicker can be obtained.

As described above, the drive illustrated by FIGS. 8 to 10 can achieve a 70-gray-level intermediate brightness display with 12 subfields, while suppressing flicker and dynamic image pseudo-contour. As a result, the number of brightness levels can be increased by comparison with the case of employing a drive method illustrated by FIG. 2 and FIG. 4. In FIG. 2 and FIG. 4, the intermediate brightness display of (N+1) gray levels is carried out with N subfields with the object of suppressing the dynamic image pseudo-contour. In this embodiment, therefore, the increase in the number of gray levels, which should depend upon multitoning such as error diffusion processing and dithering, can be reduced and noise in the displayed image can be accordingly reduced.

The second embodiment employs the so-called selective write address method to drive the PDP 10 with a plurality of subfields. In the selective write address method, a wall charge is selectively formed in each discharge cell according to the pixel data. However, the present invention can be similarly applied to driving by employing the so-called selective erasure address method. In the selective erasure address method, a wall charge is formed in advance in all the discharge cells and the wall charge is selectively erased according to the pixel data.

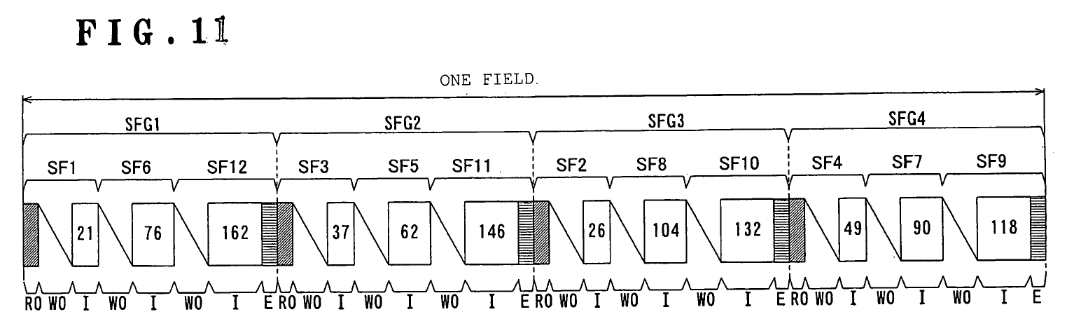

FIG. 11 illustrates a light emission drive sequence according to a third embodiment. Similar reference numerals are used in the first and third embodiments.

The light emission drive sequence shown in FIG. 11 is based on a selective erasure address method. One field is divided into twelve subfields SF1-SF12. In this light emission drive sequence, the address stage W0 and sustain stage I are executed in each of the subfields SF1-SF12. The panel drive unit includes an address driver 20, an Y electrode driver 30, an X electrode driver 40, and a drive control circuit 50. In the address stage W0, the panel drive unit selectively induces an erasure address discharge in the discharge cells of the PDP 10 according to pixel drive data derived from the input video signal. Wall charges that are formed inside the discharge cells are eliminated (neutralized) by such erasure address discharge and those discharge cells are set into a non-light emission mode. On the other hand, the discharge cells in which no erasure address discharge is induced sustain the immediately preceding state (light emission mode or non-light emission mode). In other words, the address stage W0 sets each discharge cell to either the light emission mode or the erasure mode according to the pixel drive data. In each sustain stage I, the panel drive unit causes a repeated sustain discharge light emission only in the discharge cells that are set into the light emission mode for a period that is allocated in advance to the subfield SF to which the sustain stage I belongs. The ratio of discharge light emission periods allocated to sustain periods I of the subfields SF1-SF12 is:
SF1: 21
SF2: 26
SF3: 37
SF4: 49
SF5: 62
SF6: 76
SF7: 90
SF8: 104
SF9: 118
SF10: 132
SF11: 146
SF12: 162.

In the light emission drive sequence shown in FIG. 11, the subfields SF1-SF12 are arranged in each field in the following order.
SF1
SF6
SF12
SF3
SF5
SF11
SF2
SF8
SF10
SF4
SF7
SF9

The subfields SF1, SF6, and SF12 form the first subfield group SFG1, the subfields SF3, SF5, and SF11 form the second subfield group SFG2, the subfields SF2, SF8, and SF10 form the third subfield group SFG3, and the subfields SF4, SF7, and SF9 form the fourth subfield group SFG4. The total period of sustain discharge light emission induced in the sustain stages I of each subfield group SFG1-SFG4 is as follows:
SFG1: 259 (=21+76+162)
SFG2: 245 (=37+62+146)
SFG3: 262 (=26+104+132)
SFG4: 257 (=49+90+118)

In other words, the total periods of sustain discharge in the head period (SFG1) to the last period (SFG4) of one field are almost uniform.

In the light emission drive sequence shown in FIG. 11, a reset stage R0 is executed prior to the address stage W0 in the head subfield of each subfield group SFG1-SFG4. In this reset stage R0, the panel drive unit induces a reset discharge in all the discharge cells and forms wall charges of prescribed quantity inside all the discharge cells. As a result, all the discharge cells are initialized into a light emission mode. In the light emission drive sequence shown in FIG. 11, an erasure state E is executed immediately after the sustain stage I in the last subfield of each subfield group SFG1-SFG4. In the erasure stage E, the panel drive unit induces erasure discharge in all the discharge cells and eliminates the wall charges remaining inside the discharge cells.

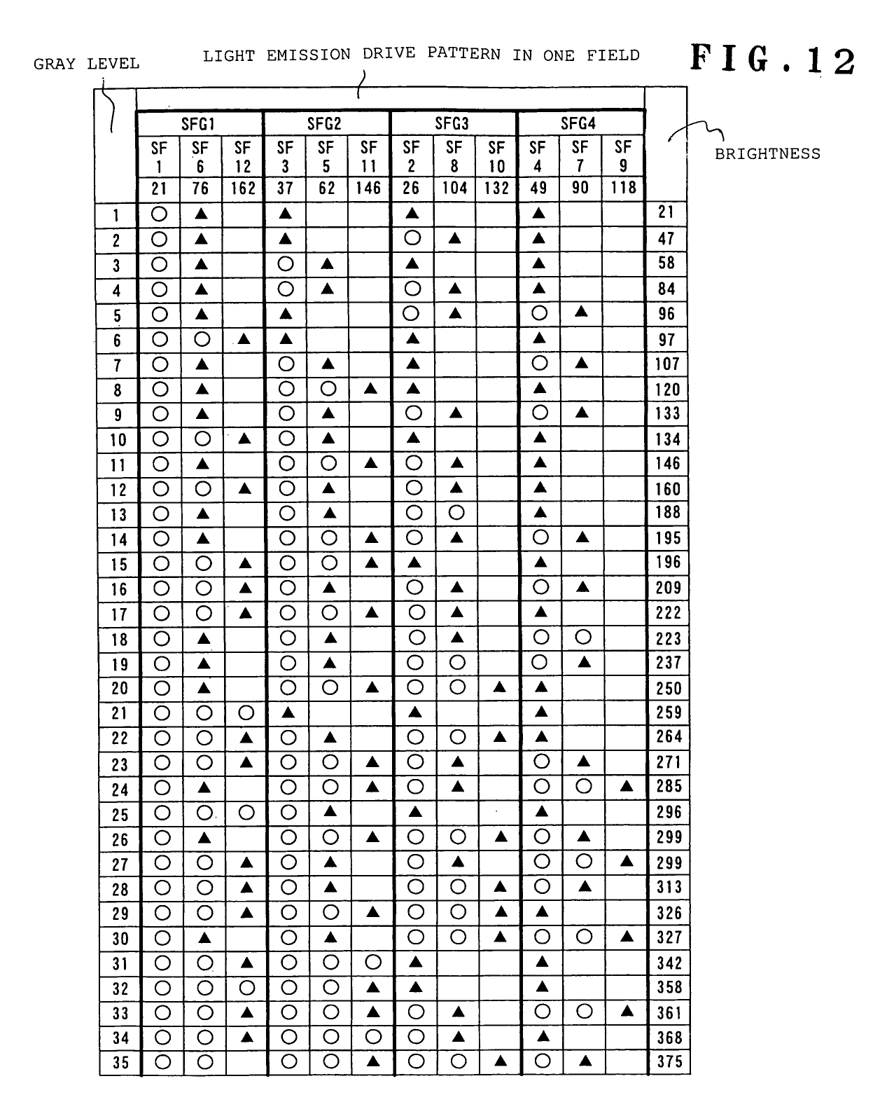

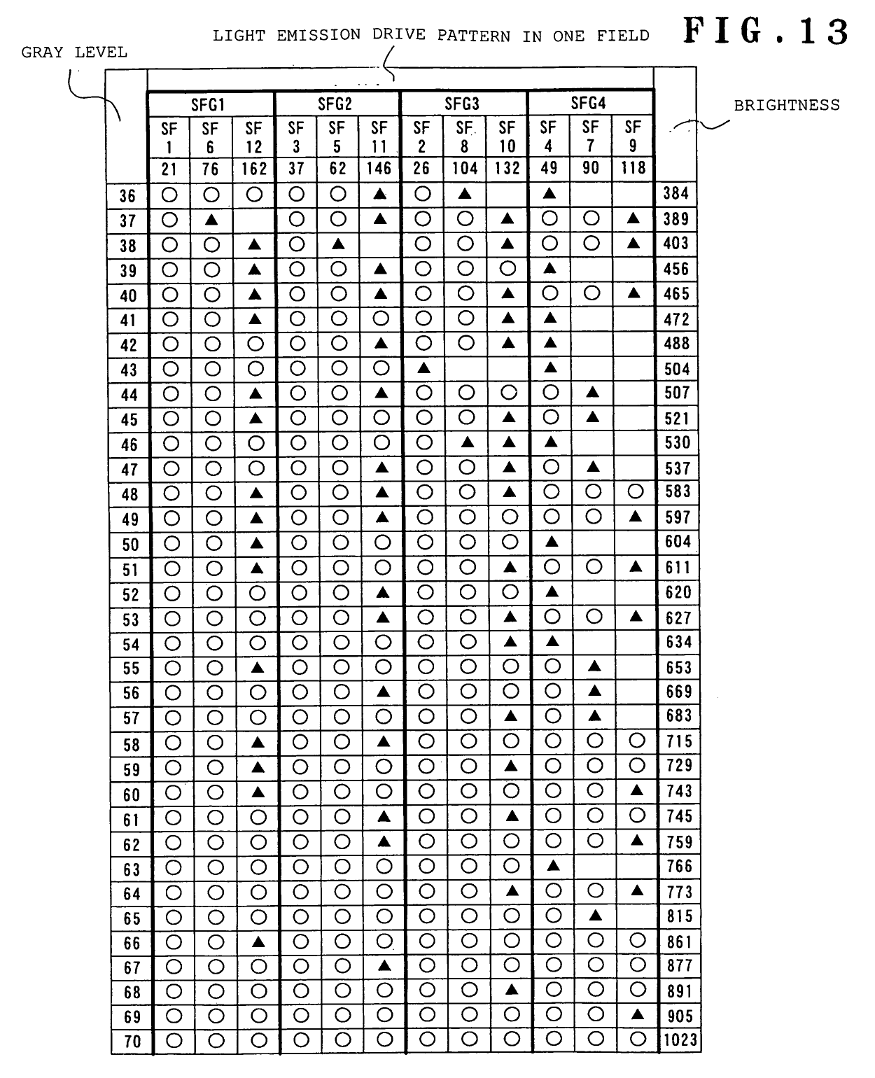

FIG. 12 and FIG. 13 illustrate in combination the light emission drive pattern based on the light emission drive sequence shown in FIG. 11.

As shown in FIG. 12 and FIG. 13, an erasure address discharge is induced in the address stages W0 of those subfields SF which are denoted by the triangular symbols, and these discharge cells are set into a non-light emission mode. The sustain discharge is induced in the sustain stages I of those subfields SF which are denoted by the white circles. For example, with the 9^{th} gray level drive illustrated in FIG. 12, light emission accompanying the sustain discharge is repeatedly executed for a certain period (i.e., certain number of times) in the sustain stage I of each subfield SF1, SF3, SF2, and SF4. The light emission period is unique to the subfield. In the third embodiment, 21 sustain discharges are executed in the subfield SF1, 37 sustain discharges are executed in the subfield SF3, 26 sustain discharges are executed in the subfield SF2, and 49 sustain discharges are executed in the subfield SF4. Thus, a brightness corresponding to a total period of “133” can be viewed.

Therefore, the light emission discharge drive pattern shown in FIG. 12 and FIG. 13 can provide 70-gray-level intermediate brightness display. This display represents “21”-“1023” viewable brightness levels in 70 gray levels.

With the drive shown in FIG. 11 to FIG. 13, the mode of discharge cell can be changed from the non-light emission mode to the light emission mode in only the reset stage R0 of the head subfield SF1, SF3, SF2, and SF4 in the subfield group SFG1-SFG4. Therefore, if a discharge cell is set into a non-light emission mode in any one address stage W0 in the three subfields in each subfield group SFG, then the non-light emission mode will be thereafter sustained till the very last subfield in the subfield group SFG.

As shown in FIG. 12 and FIG. 13, the number of times that the state (light emission mode or non-light emission mode) of the discharge cell is reversed between adjacent gray levels is 7 at maximum in the subfields SF1-SF12 (for example, between the 30th gray level and 31st gray level), that is, less than 8. Therefore, the dynamic image pseudo-contour can be suppressed if compared with a drive method having a light emission drive pattern in which the states of discharge cells of all the subfields SF1-SF12 are reversed between the adjacent gray levels (that is, the light emission drive pattern in which the number of reversions is 12).

Further, with the drive shown in FIGS. 11 to 13, the total periods of sustain discharge in the respective subfield groups SFG1-SFG4 are almost the same. Therefore, the visual brightness levels in the head period (SFG1), first intermediate period (SFG2), second intermediate period (SFG3), and end period (SFG4) of one field display period are almost uniform. Accordingly, a good image display in which a flicker is suppressed can be obtained.

As described above, with the drive employing a selective erasure address method, an intermediate brightness display with 70 gray levels is performed with 12 subfields, while suppressing flicker and dynamic image pseudo-contour. As a result, the number of brightness levels can be increased by comparison with the case of employing a drive method illustrated by FIG. 2 and FIG. 4, in which intermediate brightness display of (N+1) gray levels is carried out with N subfields with the object of suppressing the dynamic image pseudo-contour. Therefore, the increase in the number of gray levels, which should depend upon multitoning such as error diffusion processing and dithering, can be reduced and noise in the displayed image can be accordingly reduced.

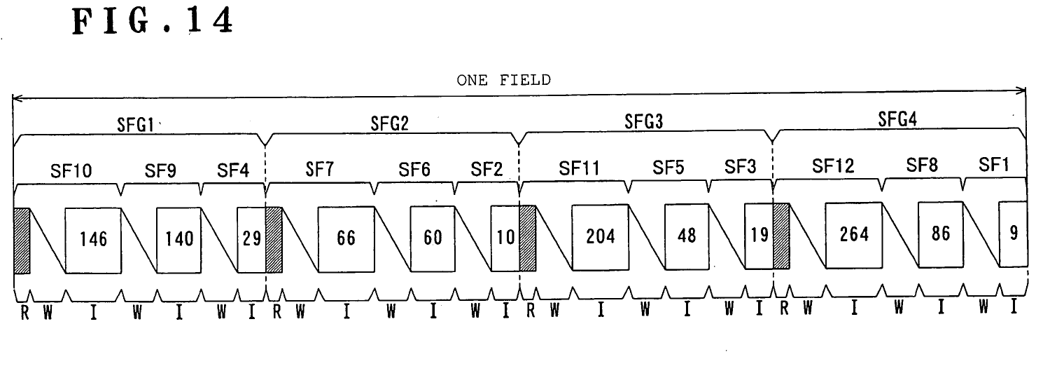

FIG. 14 illustrates a light emission drive sequence based on the selective write address method according to a fourth embodiment. Similar reference numerals are used in the first and fourth embodiments. One field is divided into twelve subfields SF1-SF12.

In the light emission drive sequence shown in FIG. 14, an address stage W and sustain stage I are executed in each of the subfields SF1-SF12. The operations of address stages W and sustain stages I are identical to those shown in FIG. 6 and FIG. 7. In the light emission drive sequence shown in FIG. 14, the ratio of discharge light emission periods allocated to the sustain periods I of the subfields SF1-SF12 is as follows:
SF1: 9
SF2: 10
SF3: 19
SF4: 29
SF5: 48
SF6: 60
SF7: 66
SF8: 86
SF9: 140
SF10: 146
SF11: 204
SF12: 264.

In the light emission drive sequence shown in FIG. 14, the subfields SF1-SF12 are arranged in the following order in each field.
SF10
SF9
SF4
SF7
SF6
SF2
SF11
SF5
SF3
SF12
SF8
SF1

The subfields SF10, SF9, and SF4 form the first subfield group SFG1, the subfields SF7, SF6, and SF2 form the second subfield group SFG2, the subfields SF11, SF5, and SF3 form the third subfield group SFG3, and the subfields SF12, SF8, and SF1 form the fourth subfield group SFG4. The total period of sustain discharge light emission induced in the sustain stages I of each subfield group SFG1-SFG4 is as follows:
SFG1: 315 (=146+140+29)
SFG2: 136 (=66+60+10)
SFG3: 271 (=204+48+19)
SFG4: 359 (=264+86+9)

Similar to the light emission drive sequence shown in FIG. 6, a reset stage R is executed prior to the address stage W in the head subfield, that is, the subfields SF10, SF7, SF11, and SF12, of each subfield group SFG1-SFG4. The operation in this reset stage R is identical to that shown in FIG. 6 and FIG. 7.

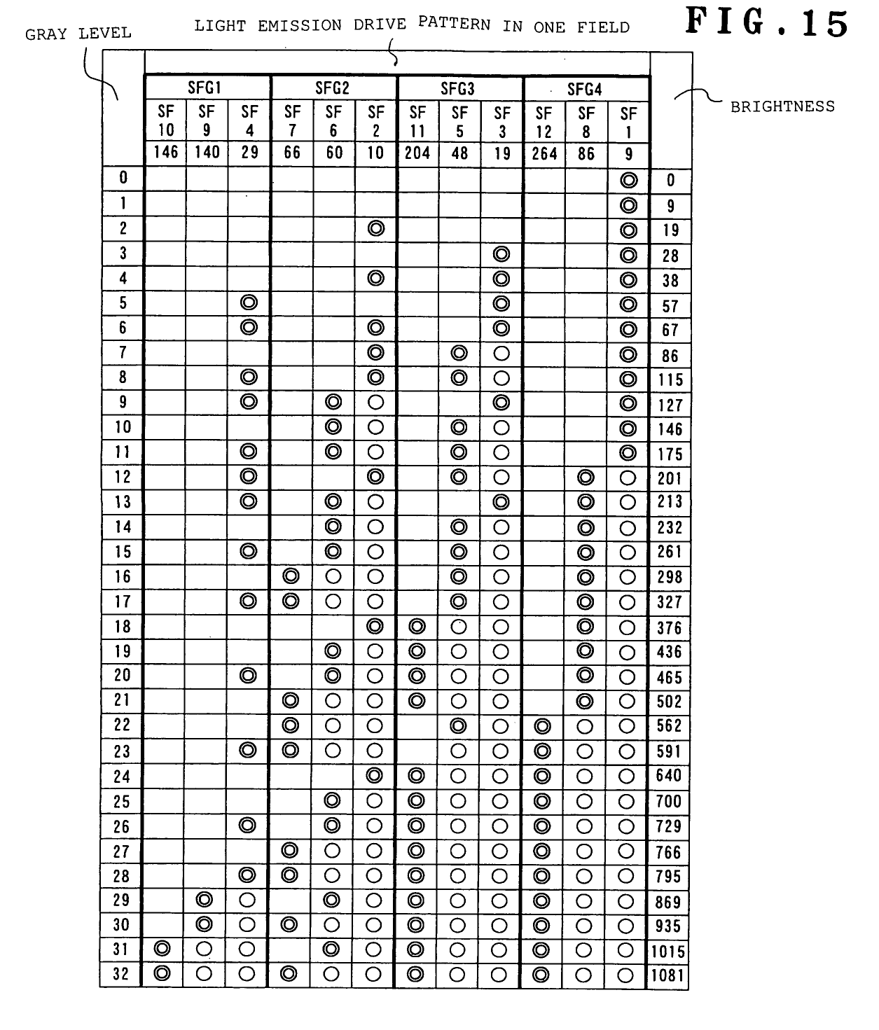

FIG. 15 illustrates the light emission drive pattern based on the light emission drive sequence shown in FIG. 14.

As shown in FIG. 15, a write address discharge is induced in the address stage W of that subfield SF which is denoted by the double circle, and such discharge cell is set into a light emission mode. Light emission accompanying the sustain discharge is induced in the sustain stage I of that subfield SF which is denoted by the double circle or white circle.

The light emission discharge drive pattern shown in FIG. 15 can achieve 33-gray-level intermediate brightness display. This display represents “0”-“1081” viewable brightness levels in 33 gray levels.

With the drive shown in FIG. 14 and FIG. 15, the mode of the discharge cell can be changed from the light emission mode to the non-light emission mode in only the reset stage R of the head subfield in each subfield group SFG1-SFG4. Therefore, if a discharge cell is set into a light emission mode in any one address stage W in the three subfields in each subfield group SFG, then the light emission mode will be thereafter sustained till the very last subfield in the subfield group SFG.

As shown in FIG. 15, the number of times that the state (light emission mode or non-light emission mode) of the discharge cell is reversed between adjacent gray levels is 4 at maximum in the subfields SF1-SF12 (for example, between the 17th gray level and 18th gray level), that is, less than 5. Therefore, the dynamic image pseudo-contour can be suppressed if compared with a drive method having a light emission drive pattern in which the states of discharge cells of all the subfields SF1-SF12 are reversed between the adjacent gray levels (that is, the light emission drive pattern in which the number of reversions is 12).

With the drive shown in FIGS. 14 and 15, an intermediate brightness display with 33 gray levels is performed with 12 subfields, while suppressing the dynamic image pseudo-contour.

This application is based on Japanese Patent Application No. 2003-330387 filed on Sep. 22, 2003, and the entire disclosure thereof is incorporated herein by reference.

1. A drive method for causing a display panel to perform gray level display based on an input video signal, the display panel having a plurality of display cells that serve as pixels, wherein the display panel is driven field by field, each said field has N (N is integer of 2 or more) subfields, each said subfield has an address stage and a sustain stage, the address stage sets said each display cell into either a light emission mode or a non-light emission mode according to pixel data derived from the input video signal, and the sustain stage causes only the display cell that has been set into the light emission mode to emit light over a light emission period that has been allocated in advance,
wherein each said field is divided into a plurality of subfield groups, each said subfield group has M (2≦M≦N/2) subfields that are successively arranged, the subfields in each subfield group are arranged in the order of increasing or decreasing allocation of the light emission period, and a total period of the light emission periods that have been allocated for the subfields belonging to one of the subfield groups is almost equal to a total period of the light emission periods that have been allocated to the subfields belonging to another one of said subfield groups, and
wherein in each said subfield group, a state of the display cell is changed from the light emission mode to the non-light emission mode, or from the non-light emission mode to the light emission mode only in the address stage of one subfield among the M subfields.

2. The drive method for a display panel according to claim 1, wherein the number of times that, within one said field, the state of said display cell that has been set to either the light emission mode or the non-light emission mode is reversed between adjacent gray levels is less than a prescribed number.

3. The drive method for a display panel according to claim 1, wherein in each said subfield group, a reset stage is executed to the display cell prior to the address stage of a first subfield in said subfield group, so as to initialize the display cell into a non-light emission mode, and the state of the display cell is changed from the non-light emission mode to the light emission mode in only the address stage of one subfield in said subfield group.

4. The drive method for a display panel according to claim 3, wherein the display cell that changes to the light emission mode in the address stage of said one subfield sustains light emission in only the sustain stages of said one subfield and following subfields in said subfield group.

5. The drive method for a display panel according to claim 1, wherein in each said subfield group, a reset stage is executed to the display cell prior to the address stage of a first subfield in said subfield group, so as to initialize the display cell into the light emission mode, and the state of the display cell is changed from the light emission mode to the non-light emission mode in only the address stage of one subfield in said subfield group.

6. The drive method for a display panel according to claim 5, wherein the display cell that changes to the non-light emission mode in the address stage of said one subfield sustains light emission in only the sustain stages of subfields preceding said one subfield in said subfield group.

7. The drive method for a display panel according to claim 1, wherein the field is divided into three subfield groups, and each said subfield group includes three subfields.

8. The drive method for a display panel according to claim 1, wherein the field is divided into four subfield groups, and each said subfield group includes three subfields.
